(19) United States
(12) Patent Application Publication
(10) Pub. No.: US 2011/0070844 A1
(43) Pub. Date: Mar. 24, 2011

(54) ELECTRONIC APPARATUS AND DATA COMMUNICATION SYSTEM

(75) Inventor: Satoshi YOKOTE, Oume-shi (JP)

(73) Assignee: KABUSHIKI KAISHA TOSHIBA, Tokyo (JP)

(21) Appl. No.: 12/890,454

(22) Filed: Sep. 24, 2010

(30) Foreign Application Priority Data
Sep. 24, 2009 (JP) 2009-218553

(51) Int. Cl. H04B 1/44

(52) U.S. Cl. 455/78

(57) ABSTRACT

An electronic apparatus includes a communication module configured to execute a wireless communication in a transmission mode for sending data to a counterpart electronic apparatus or a reception mode for receiving data from a counterpart electronic apparatus, an orientation detector configured to detect orientation of the electronic apparatus, and a communication controller configured to switch between the transmission mode and the reception mode according to the orientation of the electronic apparatus detected by the orientation detector.

### CROSS REFERENCE TO RELATED APPLICATION(S)

The present disclosure relates to the subject matters contained in Japanese Patent Application No. 2009-218553 filed on Sep. 24, 2009, which are incorporated herein by reference in its entirety.

### BACKGROUND

1. Field

One embodiment of the invention relates to an electronic apparatus and a data communication system.

2. Description of the Related Art

Various kinds of information have come to be stored in portable terminals. It is a common procedure that data stored in a portable terminal is transferred or copied to an electronic apparatus such as a PC to generate backup data. A technique capable of simplifying such a data transfer operation is disclosed in which data is transmitted when it is detected that an originating portable terminal is inclined by more than a prescribed angle (refer to JP-A-2007-193546 (KOKAI), for example).

However, the above technique is directed to an originating apparatus and there is no disclosure as to a receiver apparatus. A data communication is executed when an originating apparatus is set to a data transmission mode and a receiver apparatus is set to a data reception mode. That is, to simplify the data communication, it is necessary that the operation of the receiver apparatus also be improved, that is, be such as to facilitate a transition to the data reception mode.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary diagram showing an appearance of a communication apparatus according to a first embodiment of the invention as viewed from the side of a front face;

FIG. 2 is an exemplary diagram showing the appearance of the communication apparatus according to the first embodiment of the invention as viewed from the side of a back face;

FIG. 3 is an exemplary diagram showing a communication state of the communication apparatus according to the first embodiment of the invention;

FIG. 4 is an exemplary diagram showing an internal configuration of the communication apparatus according to the first embodiment of the invention;

FIG. 5 is an exemplary functional block diagram of the communication apparatus according to the first embodiment of the invention;

FIG. 6 is an exemplary flowchart of a communication control process which is executed by the communication apparatus according to the first embodiment of the invention;

FIG. 7 is an exemplary diagram showing a communication state of a communication apparatus according to a second embodiment of the invention;

FIG. 8 is an exemplary diagram showing a communication state of a communication apparatus according to a third embodiment of the invention; and

FIG. 9 is an exemplary flowchart of a communication control process which is executed by the communication apparatus according to the third embodiment of the invention.

### DETAILED DESCRIPTION

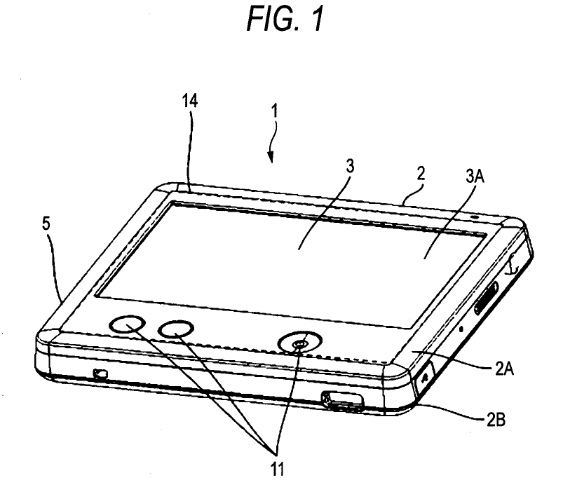

Various embodiments of the present invention will be hereinafter described with reference to FIGS. 1-9.

A communication apparatus 1 as an example electronic apparatus according to the embodiments of the invention will be described below. The communication apparatus 1 is a mobile PC, a UMPC (ultra-mobile PC), a PDA (personal digital assistant), a cell phone, or the like. Although it is described in the following embodiments that the communication apparatus 1 is an apparatus having a box-shaped case, the invention is not limited to such a case. That is, the communication apparatus 1 may be an apparatus in which a display module and a main body module are housed in separate cases and which is equipped with a rotary mechanism.

The configuration of a communication apparatus 1 according to a first embodiment of the invention will be described with reference to FIGS. 1-3. Communication apparatus are denoted by reference symbols “1A” and “1B” when they are described separately and denoted by reference symbol “1” when they need not.

FIG. 1 shows an appearance of the communication apparatus 1 according to the first embodiment as viewed from the side of a front face 14. The communication apparatus 1 includes a case 2, a display 3, a speaker 5, a communication antenna 7, an acceleration sensor 9, and an user interface 11. In the first embodiment, the face provided with the display 3 is called the front face 14 and the face opposite to the front face 14 is called a back face 15. Frontal orientation of the communication apparatus 1 is defined as such orientation that the front face 14 is seen when the communication apparatus 1 is viewed from right above. Backward orientation of the communication apparatus 1 is defined as such orientation that the back face 15 is seen when the communication apparatus 1 is viewed from right above.

The case 2 is assembled by fitting a case cover 2A into or with a case base 2B. Various electronic components are housed in the case 2.

The display 3 occupies a central space of the case cover 2A and displays, for example, data to be sent or received by the communication apparatus 1. A touchscreen 3A is laid on the front face of the display 3. The touchscreen 3A is an input device for inputting an operation signal corresponding to information displayed on the display 3 when the user touches the touchscreen 3A at a display position of the information. Instead of the touchscreen 3A, a tablet (digitizer) may be used which enables position indication with a pen or the like.

The speaker 5 is provided in the left-hand face of the case 2 so as to be exposed, and outputs a sound corresponding to data that is played back by the communication apparatus 1, an indicator sound, etc.

The communication antenna 7 is an antenna that is configured so as to enable data exchange with another communication apparatus 1 by executing a wireless communication with it.

The acceleration sensor 9 is a sensor for detecting acceleration of the communication apparatus 1. For example, the acceleration sensor 9 includes a movable section which moves when acceleration occurs, a spring, and electrodes whose capacitance varies depending on the movement distance of the movable section. The acceleration sensor 9 outputs, to a status detection module 10, a signal that is generated based on a capacitance variation.

The status detection module 10 detects an inclination or a movement of the communication apparatus 1, vibration or impact acting on the communication apparatus 1, etc. by performing proper signal processing on data that is generated by the acceleration sensor 9 and indicates acceleration of the communication apparatus 1. In the embodiment, the status detection module 10 includes an orientation detector 10A and a movement detector 10B.

The user interface 11 consists of buttons that occupy openings formed on the case cover 2A and accept various operations made by the user.

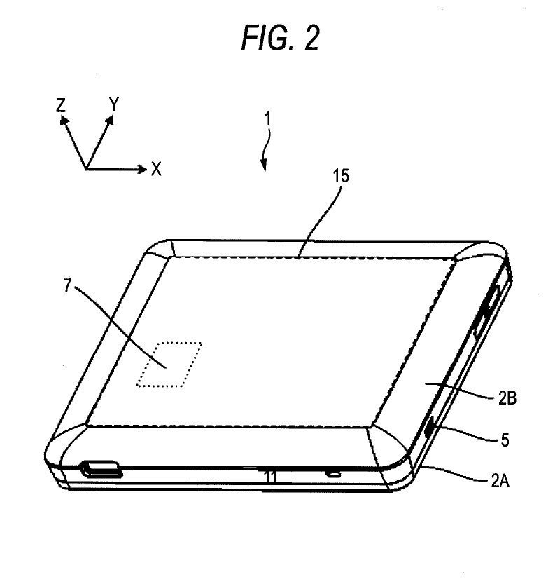

FIG. 2 shows an appearance of the communication apparatus 1 according to the first embodiment as viewed from the side of the back face 15. The communication antenna 7 is housed in the case 2. The communication direction of the communication antenna 7 is the direction toward the back face 15 (i.e., the positive direction along the Z axis shown in FIG. 2). A wireless communication is executed in a state that the back faces 15 of communication apparatuses 1 are opposed to each other in the Z direction.

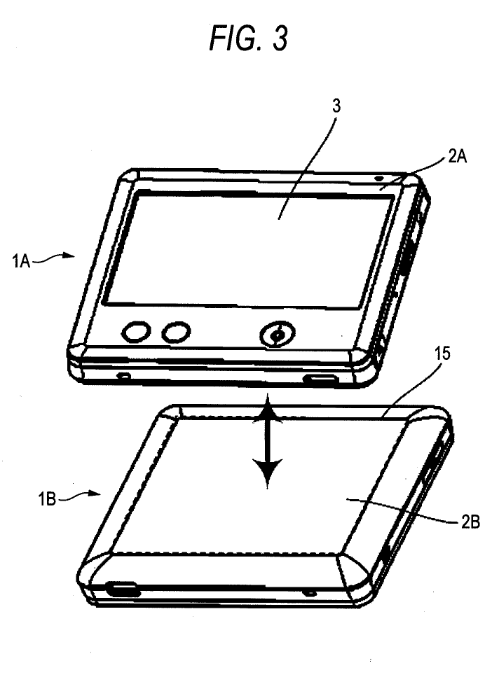

FIG. 3 shows a communication state of communication apparatuses 1A and 1B according to the first embodiment. The communication apparatuses 1A and 1B communicate with each other in a state that their back faces 15 are opposed to each other. The first embodiment assumes a wireless communication having a communication distance of several centimeters.

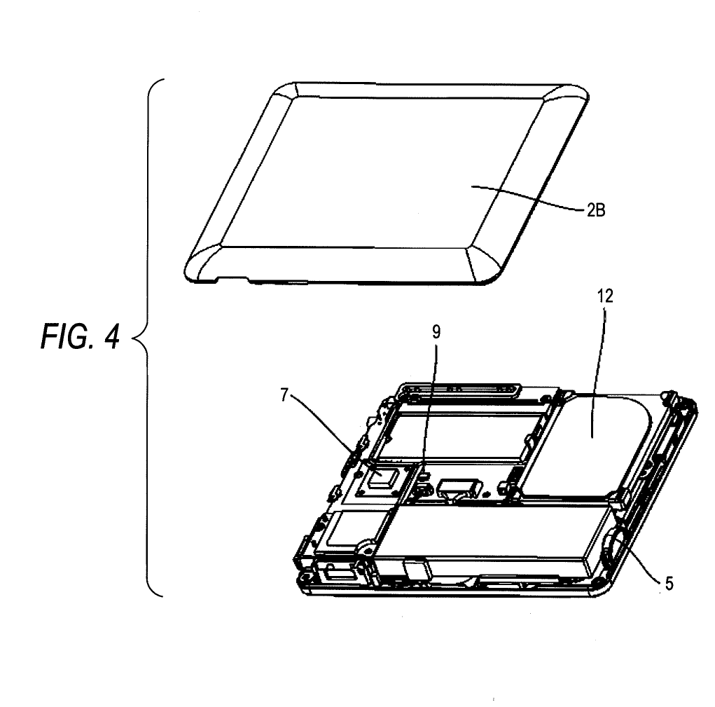

FIG. 4 shows the internal configuration of the communication apparatus 1 according to the first embodiment. FIG. 4 shows a state that the communication apparatus 1 has backward orientation and the case base 2B is removed. The speaker 5, the communication antenna 7, the acceleration sensor 9, and an HDD 12 are housed in the case 2.

Data to be sent or received via the communication antenna 7 is stored in the HDD 12. The HDD 12 includes a specified folder in which data to be sent or received by a wireless communication. When the communication mode of the communication apparatus 1 is the transmission mode, a file in the specified folder is sent to a counterpart communication apparatus 1. That is, in the transmission mode, a communication controller 8 reads out file data from the specified folder of the HDD 12 and outputs it to the communication antenna 7. When the communication mode of the communication apparatus 1 is the reception mode, file data transmitted from the counterpart is stored in the specified folder. That is, in the reception mode, the communication controller 8 stores file data received via the communication antenna 7 in the specified folder of the HDD 12.

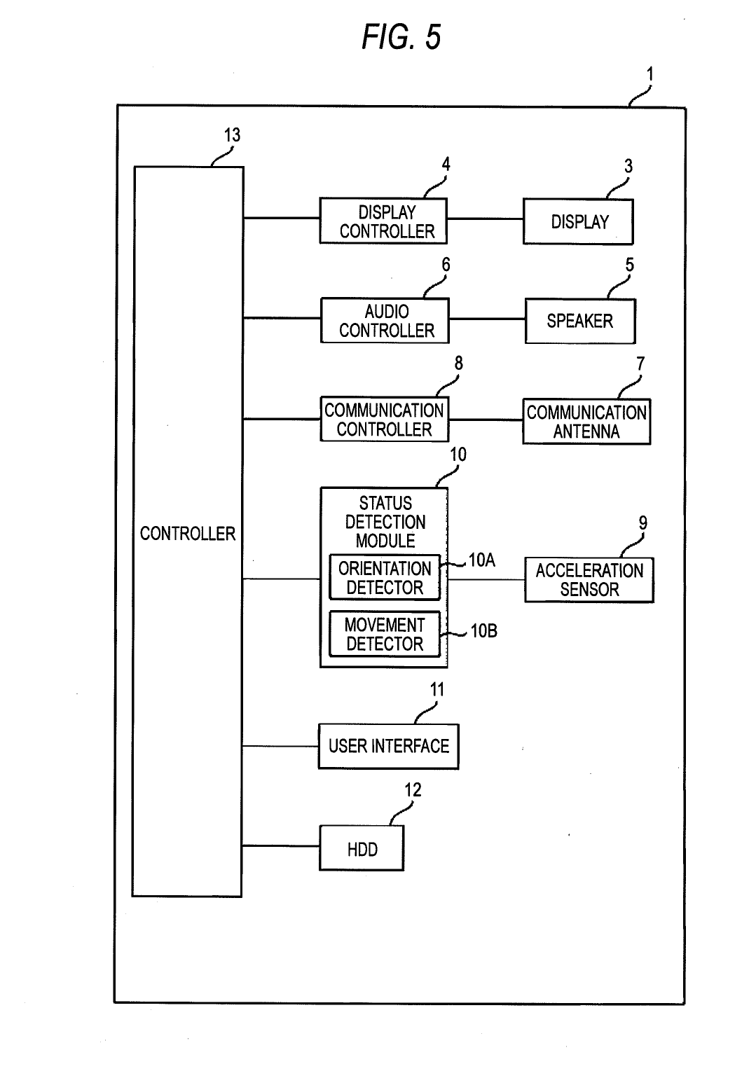

FIG. 5 is a functional block diagram of the communication apparatus 1 according to the first embodiment.

The communication apparatus 1 includes the display 3, a display controller 4, the speaker 5, an audio controller 6, the communication antenna 7, the communication controller 8, the acceleration sensor 9, the status detection module 10, the user interface 11, the HDD 12, and a controller 13.

The display 3 displays video based on a video signal received from the display controller 4.

The display controller 4 generates a video signal based on a control signal that is input from the controller 13, and outputs the generated video signal to the display 3.

The speaker 5 outputs a sound based on an audio signal received from the audio controller 6.

The audio controller 6 generates an audio signal based on a control signal that is input from the controller 13, and outputs the generated audio signal to the speaker 5.

The communication controller 8 executes a wireless communication while switching between the transmission mode and the reception mode. More specifically, the communication controller 8 performs a control as to whether to set the transmission mode or the reception mode based on a detection result of state information relating to the communication apparatus 1 that is input from the status detection module 10. In the first embodiment, orientation of the communication apparatus 1 is detected by the orientation detector 10A and the communication controller 8 sets the transmission mode if the communication apparatus 1 has frontal orientation. In the example of FIG. 3, the communication controller 8 sets the transmission mode in the communication apparatus 1A and sets the reception mode in the communication apparatus 1B. In this manner, the communication mode can be switched according to the orientation of the communication apparatus 1.

The status detection module 10 detects orientation and a movement based on data indicating acceleration of the communication apparatus 1 that is detected by the acceleration sensor 9. The status detection module 10 outputs detection results to the controller 13. More specifically, the orientation detector 10A detects whether the communication apparatus 1 has frontal orientation or not and the movement detector 10B detects whether the communication apparatus 1 is moving or not as well as a movement direction.

The user interface 11 receives an operation made by the user, generates a signal indicating the operation, and outputs the generated signal to the controller 13. For example, the user interface 11 may be buttons that are disposed so as to be exposed from the case cover 2A or the touchscreen 3A.

The controller 13 controls the operations of the individual modules and the like of the communication apparatus 1. More specifically, the controller 13 controls them by activating a system control program and various kinds of processing programs that are stored in advance according to a signal that is input from the user interface 11.

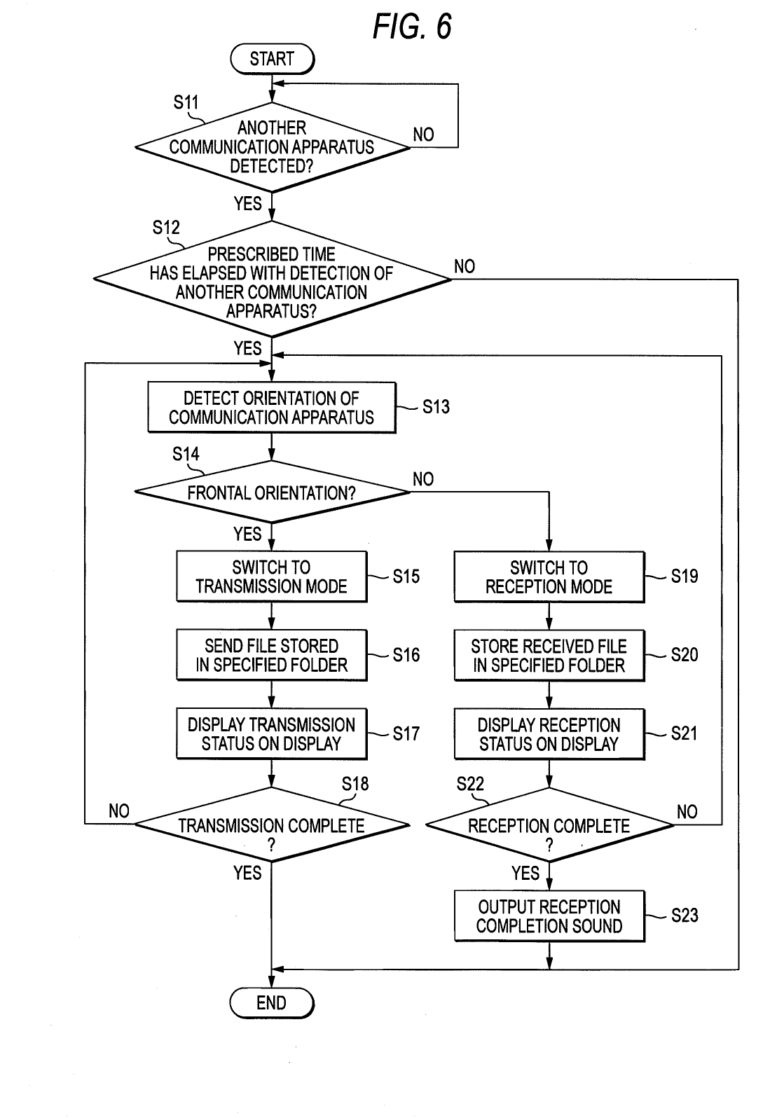

FIG. 6 is a flowchart of a communication control process of the communication apparatus 1A according to the first embodiment. The communication control process which is executed by the communication controller 8 of the communication apparatus 1A will be described below with reference to FIG. 6.

First, at step S11, the communication controller 8 determines whether or not it detects a counterpart communication apparatus 1B via the communication antenna 7, that is, whether or not a counterpart communication apparatus 1B exists within the communication distance of the communication apparatus 1A in a state that the back faces 15 of the communication apparatuses 1A and 1B are opposed to each other.

If it is determined that a counterpart communication apparatus 1B is not detected (S11: no), the process returns to step S11. On the other hand, if determined that a counterpart communication apparatus 1B is detected, the communication controller 8 determines at step S12 whether or not a prescribed time has elapsed in a state that the communication apparatus 1B is kept detected. Setting the prescribed time at several seconds and detecting continuation of the detection of the communication apparatus 1B allow a determination that the back faces 15 of the communication apparatuses 1A and 1B are opposed to each other for a wireless communication rather than accidentally. Time measurement is performed by using a clock that is incorporated in the controller 13.

If it is determined that the prescribed time has not elapsed yet in a state that the communication apparatus 1B is kept detected (S12: no), the communication control process is finished. That is, a wireless communication is not executed if the communication apparatus 1B that was detected at step S11 is moved before a lapse of the prescribed time.

On the other hand, if it is determined that the prescribed time has elapsed in a state that the communication apparatus 1B is kept detected (S12: yes), orientation of the communication apparatus 1A is detected at step S13. This is done by the orientation detector 10A based on data indicating acceleration of the communication apparatus 1A that is detected by the acceleration sensor 9.

At step S14, the communication controller 8 determines whether or not the communication apparatus 1A has frontal orientation based on the detection result of the orientation detector 10A. If determined that the communication apparatus 1A has frontal orientation (S14: yes), at step S15 the communication controller 8 switches to the transmission mode. At step S16, the communication controller 8 sends file data stored in the specified folder to the counterpart communication apparatus 1B.

At step S17, the communication controller 8 displays a data transmission status on the display 3. The transmission status may be information merely indicating that the transmission is in progress or information indicating an amount of transmitted data or non-transmitted data (a total amount of file data stored in the specified folder is calculated). The communication controller 8 supplies the display controller 4 with a control signal to be used for generating a display showing a data transmission status. The display controller 4 outputs, to the display 3, a video signal representing the data transmission status based on the received control signal.

At step S18, the communication controller 8 determines whether the transmission of the data stored in the specified folder has completed or not. If it is determined that the data transmission has not completed yet (S18: no), the process returns to step S13. On the other hand, if it is determined that the data transmission has completed (S18: yes), the communication control process is finished.

If it is determined that the communication apparatus 1A has backward orientation (S14: no), at step S19 the communication controller 8 switches to the reception mode. At step S20, the communication controller 8 stores received file data in the specified folder.

At step S21, the communication controller 8 displays a data reception status on the display 3. The reception status may be information merely indicating that the reception is in progress or information indicating an amount of received data that is stored in the specified folder. The communication controller 8 supplies the display controller 4 with a control signal to be used for generating a display showing a data reception status. The display controller 4 outputs, to the display 3, a video signal representing the data reception status based on the received control signal.

Step S21 may be omitted. That is, the display of a data reception status may be omitted because the display 3 of the communication apparatus 1A in which the reception mode is set is directed downward and hence the user has difficulty recognizing a display on it.

At step S22, the communication controller 8 determines whether the reception (and the storage into the specified folder) of the data has completed or not. If it is determined that the data reception has not completed yet (S22: no), the process returns to step S13. On the other hand, if determined that the data reception has completed (S22: yes), at step S23 the communication controller 8 outputs a reception completion sound from the speaker 5. That is, if determined that the data reception has completed, the communication controller 8 supplies the audio controller 6 with a control signal to be used for generating a reception completion sound. The audio controller 6 outputs, to the speaker 5, an audio signal of the reception completion sound based on the received control signal. The speaker 5 outputs the reception completion sound based on the received audio signal. The communication control process is thus completed.

According to the above-described first embodiment of the invention, the data communication can be simplified by switching the communication mode according to the orientation of the communication apparatus 1. That is, in starting a wireless communication, the communication apparatuses 1A and 1B can be set to the transmission mode or the reception mode by giving them frontal orientation or backward orientation without the need for making operations for setting them to the transmission mode or the reception mode.

Since the transmission mode is set if the back face 15 of the communication apparatus 1A is directed downward, a data communication is executed in a state that the counterpart communication apparatus 1B is located under the communication apparatus 1A. When something is handed over, usually, the handing-over side is located above and the receiving side is located below. Setting the relationship between the orientation of the communication apparatus 1 and the communication mode in the manner described in the first embodiment makes it possible to execute transmission and reception of electronic data with the same positional relationship as in the case of handing-over of a thing. A more intuitive operation is thus enabled.

Although in the first embodiment a wireless communication is started when a state that the back faces 15 of the communication apparatuses 1A and 1B are opposed to each other has continued for the prescribed time, the invention is not limited to such a case.

A wireless communication may be started by making a prescribed operation on the user interface 11 after the back faces 15 was opposed to each other. Starting a wireless communication by an operation made by the user can increase the security of a data communication.

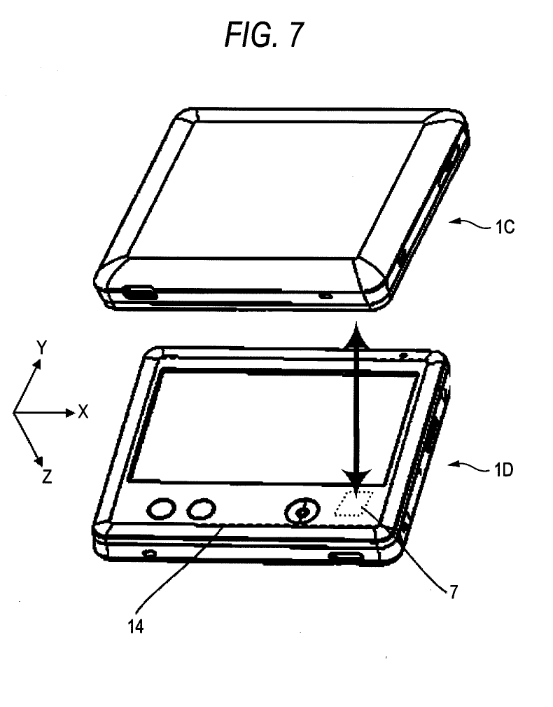

Next, a second embodiment of the invention will be described with reference to FIG. 7. FIG. 7 shows a communication state of communication apparatuses 1C and 1D according to the second embodiment.

The second embodiment is different from the first embodiment in the orientation of the communication antenna 7. The communication direction of the communication antenna 7 is the direction toward the front face 14 (i.e., the negative direction along the Z axis shown in FIG. 7). A wireless communication is executed in a state that the front faces 14 are opposed to each other in the Z direction.

In the second embodiment, the transmission mode is set if the communication apparatus 1 has frontal orientation. In the example of FIG. 7, the transmission mode is set in a communication apparatus 1D and the reception mode is set in a communication apparatus 1C having backward orientation. In this manner, the communication mode can be switched according to the orientation of the communication apparatus 1.

The communication control process according to the second embodiment is the same as that according to the first embodiment and hence will not be described below. Since a wireless communication is executed in a state that the front faces 14 are opposed to each other, the user cannot recognize a status of a data communication. However, the user can recognize completion of a data communication by causing the communication apparatus 1C in the reception mode to output a reception completion sound.

According to the above-described second embodiment, since the transmission mode is set in the communication apparatus 1 having frontal orientation, data transmission to multiple communication apparatus 1 can be executed more smoothly. That is, data can be transmitted to multiple communication apparatus 1 by bringing the multiple communication apparatus 1 to receive data close to the communication apparatus 1D one after another without moving the communication apparatus 1D which is in the transmission mode.

Although in the first and second embodiments the transmission mode is set when the communication apparatus 1 has frontal orientation, the invention is not limited to such a case. That is, the communication apparatus 1 may be configured so that the relationship between the orientation of the communication apparatus 1 and the communication mode can be set by the user.

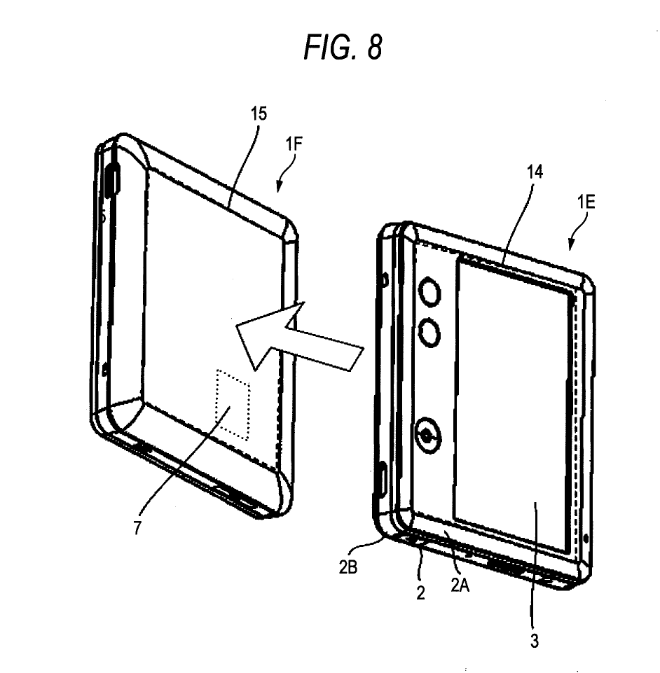

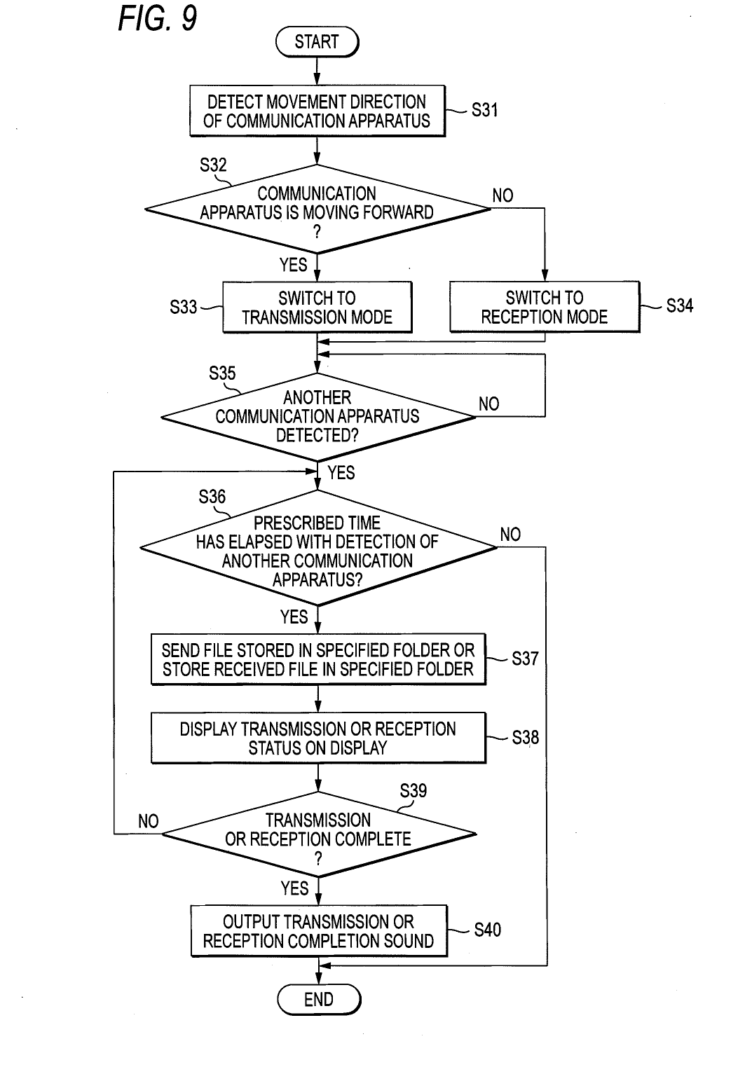

Next, a third embodiment of the invention will be described below with reference to FIGS. 8 and 9. FIG. 8 shows a communication state of communication apparatuses 1E and 1F according to the third embodiment. In the third embodiment, the communication mode is switched according to the movement of the communication apparatus 1 rather than its orientation.

As shown in FIG. 8, the communication direction of the communication antenna 7 of each of communication apparatuses 1E and 1F is the direction toward the back face 15. Therefore, a wireless communication is executed in a state that the back faces 15 are opposed to each other.

In the third embodiment, the communication controller 8 detects a movement and a movement direction of the communication apparatus 1 with the movement detector 10B and sets the transmission mode if the communication apparatus 1 is moving in the direction from the front face 14 to the back face 15. In the example of FIG. 8, it is assumed that the communication apparatus 1E is moving in the direction from the front face 14 to the back face 15 so as to come closer to the communication apparatus 1F. Therefore, the communication apparatus 1E is set to the transmission mode. In the following description, if the communication apparatus 1 is moving in the direction from the front face 14 to the back face 15, it is described as moving forward.

Next, how in the third embodiment the communication mode is switched according to the movement of the communication apparatus 1E will be described with reference to FIG. 9. FIG. 9 is a flowchart of a communication control process which is executed by the communication apparatus 1E according to the third embodiment.

First, at step S31, the communication controller 8 detects a movement direction of the communication apparatus 1E. A movement of the communication apparatus 1E is actually detected by the movement detector 10B based on data indicating acceleration of the communication apparatus 1E that is detected by the acceleration sensor 9.

At step S32, the communication controller 8 determines whether or not the communication apparatus 1E is moving forward based on the detection result of the movement detector 10B. If determined that the communication apparatus 1E is moving forward (S32: yes), at step S33 the communication controller 8 switches to the transmission mode. On the other hand, if determined that the communication apparatus 1E is not moving forward (S32: no), at step S34 the communication controller 8 switches to the reception mode. That is, the reception mode is set if the communication apparatus 1E is not moving or is moving backward.

At step S35, the communication controller 8 determines whether or not a counterpart communication apparatus 1F is detected via the communication antenna 7, that is, whether or not a counterpart communication apparatus 1F exists within the communication distance of the communication apparatus 1E in a state that the back faces 15 of the communication apparatuses 1E and 1F are opposed to each other.

If it is determined that a counterpart communication apparatus 1B is not detected (S35: no), the process returns to step S35. On the other hand, if determined that a counterpart communication apparatus 1F is detected, the communication controller 8 determines at step S36 whether or not a prescribed time has elapsed in a state that the communication apparatus 1F is kept detected. Setting the prescribed time at several seconds and detecting continuation of the detection of the communication apparatus 1F allow a determination that the back faces 15 of the communication apparatuses 1E and 1F are opposed to each other for a wireless communication rather than accidentally. Time measurement is performed by using a clock that is incorporated in the controller 13.

If it is determined that the prescribed time has not elapsed yet in a state that the communication apparatus 1F is kept detected (S36: no), the communication control process is finished. That is, a wireless communication is not executed if the communication apparatus 1F that was detected at step S35 is moved before a lapse of the prescribed time.

On the other hand, if it is determined that the prescribed time has elapsed in a state that the communication apparatus 1F is kept detected (S36: yes), at step S37 the communication controller 8 sends or receives a file to or from the counterpart communication apparatus 1F. That is, the communication apparatus 1E sends a file that is stored in the specified folder to the counterpart communication apparatus 1F if the communication apparatus 1E is in the transmission mode, and the communication apparatus 1E stores a received file in the specified folder if it is in the reception mode.

At step S38, the communication controller 8 displays a data transmission or reception status on the display 3. The data transmission or reception status is a start of transmission, transmission in progress, transmission complete, or the like.

At step S39, the communication controller 8 determines whether the transmission or reception of the data has completed or not. If it is determined that the data transmission or reception has not completed yet (S39: no), the process returns to step S36. On the other hand, if it is determined that the data transmission or reception has completed (S39: yes), at step S40 the communication controller 8 outputs a transmission or reception completion sound from the speaker 5. The transmission or reception completion sound is output from at least one of the communication apparatus 1 and the counterpart communication apparatus 1. If determined that the data transmission or reception has completed, the communication controller 8 of at least one of the communication apparatus 1 and the counterpart communication apparatus 1 supplies the audio controller 6 with a control signal to be used for generating a transmission or reception completion sound. The audio controller 6 outputs, to the speaker 5, an audio signal of the transmission or reception completion sound based on the received control signal. The speaker 5 outputs the transmission or reception completion sound based on the received audio signal. The communication control process is thus completed.

According to the above-described third embodiment, the transmission mode can be set in the communication apparatus 1E which is to transmit data by merely bringing it close to the communication apparatus 1F. That is, the communication mode of the communication apparatus 1 can be switched according to how the user who holds the communication apparatus 1 moves it rather than its orientation.

Although in the third embodiment the transmission mode is set by moving the communication apparatus forward, the invention is not limited to such a case. That is, the transmission mode or the reception mode may be set so as to correspond to a particular movement or manner of vibration of the communication apparatus 1 that is detected by the acceleration sensor 9.

Incidentally, the invention is not limited to the aforementioned embodiment per se and constituent members may be changed or modified for embodying the invention without departing from the gist of the invention in a practical stage. Constituent members disclosed in the aforementioned embodiment may be combined suitably to form various inventions. For example, some of all constituent members disclosed in the embodiment may be removed. In addition, constituent members disclosed in different embodiments may be combined suitably.

What is claimed is:

1. An electronic apparatus comprising:
a communication module configured to wirelessly communicate with a counterpart electronic apparatus either in a transmission mode for sending data to the counterpart electronic apparatus or in a reception mode for receiving data from the counterpart electronic apparatus;
an orientation detector configured to detect an indication of an orientation of the electronic apparatus; and
a communication controller configured to switch between the transmission mode and the reception mode according to the indication of the orientation of the electronic apparatus detected by the orientation detector.

2. The apparatus of claim 1,
wherein the communication module is configured to wirelessly communicate with the counterpart electronic apparatus facing a communication face of the electronic apparatus, and
wherein the communication controller is configured to set the transmission mode to the electronic apparatus when the orientation detector detects that the communication face is directed downward.

3. The apparatus of claim 2 further comprising:
a display module configured to display the data to be sent or received,
wherein the display module is on a face of the electronic apparatus that is opposite to the communication face.

4. The apparatus of claim 2, wherein the communication controller is configured to set the reception mode to the electronic apparatus when the orientation detector detects that the communication face is directed upward.

5. The apparatus of claim 3, wherein the electronic apparatus comprises a first case configured to house the display module, and a second case configured to house the communication module and connected to the first case with a hinge.

6. The apparatus of claim 1,
wherein the communication module is configured to wirelessly communicate with the counterpart electronic apparatus facing a communication face of a case of the electronic apparatus, and
wherein the communication controller is configured to set the transmission mode to the electronic apparatus when the orientation detector detects that the communication face is directed upward.

7. The apparatus of claim 6 further comprising:
a display module configured to display the data to be sent or received,
wherein the display module is on the communication face of the electronic apparatus.

8. The apparatus of claim 6, wherein the communication controller is configured to set the reception mode to the electronic apparatus when the orientation detector detects that the communication face is directed downward.

9. The apparatus of claim 7, wherein the electronic apparatus comprises a first case configured to house the display module and the communication module, and a second case connected to the first case with a hinge.

10. The apparatus of claim 4, wherein the display module is configured to display a status of data transmission or reception of the communication module.

11. The apparatus of claim 8, wherein the display module is configured to display a status of data transmission or reception of the communication module.

12. An electronic apparatus comprising:
a communication module configured to wirelessly communicate with a counterpart electronic apparatus either in a transmission mode for sending data to the counterpart electronic apparatus or in a reception mode for receiving data from the counterpart electronic apparatus;
a movement detector configured to detect a movement of the electronic apparatus; and
a communication controller configured to switch between the transmission mode and the reception mode according to the movement of the electronic apparatus detected by the movement detector.

13. The apparatus of claim 12,
wherein the electronic apparatus comprises a case comprising a first face which allows wireless communication between the electronic apparatus and the counterpart electronic apparatus and a second face opposite to the first face,
wherein the movement detector is configured to detect whether the electronic apparatus is moving in a direction from the second face to the first face, and
wherein the communication controller is configured to set the transmission mode when the movement detector detects that the electronic apparatus is moving in the direction from the second face to the first face.

14. The apparatus of claim 12, further comprising:
a status detection module which comprises the movement detector;
an acceleration sensor which comprises:
a moving module configured to move when acceleration occurs;
a spring; and
electrodes whose capacitance varies depending on the movement distance of the moving module,
wherein the acceleration sensor is configured to output a signal based on a capacitance variation to the status detection module.

15. The apparatus of claim 14,
wherein the status detection module is configured to detect either an inclination or a movement of the electronic apparatus, vibration or impact acting on the communication apparatus by processing the signal from the acceleration sensor and to indicate acceleration of the electronic apparatus.

16. A data communication system comprising:
two electronic apparatuses between which data is transmitted in a state that communication faces of the electronic apparatuses are opposite to each other, each electronic apparatus comprising:
a communication module configured to wirelessly communicate with a counterpart electronic apparatus either in a transmission mode for sending data to the counterpart electronic apparatus or in a reception mode for receiving data from the counterpart electronic apparatus;
an orientation detector configured to detect an indication of an orientation of the electronic apparatus; and
a communication controller configured to switch between the transmission mode and the reception mode according to the indication of the orientation of the electronic apparatus detected by the orientation detector,
wherein each electronic apparatus is configured to set to the transmission mode when the communication face is directed downward and configured to set to the reception mode when the communication face is directed upward.

17. The data communication system of claim 16,
wherein at least one of the two electronic apparatuses further comprises a movement detector configured to detect a movement of the electronic apparatus,
wherein the communication controller of the at least one electronic apparatus is configured to switch between the transmission mode and the reception mode according to the movement of the electronic apparatus detected by the movement detector.

18. The data communication system of claim 17,
wherein the at least one electronic apparatus further comprises:
a status detection module which comprises the movement detector;
an acceleration sensor which comprises:
a moving module configured to move when acceleration occurs;
a spring; and
electrodes whose capacitance varies depending on the movement distance of the moving module,
wherein the acceleration sensor is configured to output a signal based on a capacitance variation to the status detection module.

19. The data communication system of claim 18,
wherein the status detection module is configured to detect either an inclination or a movement of the at least one electronic apparatus, vibration or impact acting on the communication apparatus by processing the signal from the acceleration sensor and to indicate acceleration of the at least one electronic apparatus.
